(19) United States
(12) Patent Application Publication
(10) Pub. No.: US 2015/0319370 A1
(43) Pub. Date: Nov. 5, 2015

(54) ONBOARD IMAGE GENERATOR

(71) Applicant: DENSO CORPORATION, Aichi (JP)

(72) Inventors: Bingchen WANG, Okazaki-city (JP); Hirohiko YANAGAWA, Chiryu-city (JP)

(21) Appl. No.: 14/438,978

(22) PCT Filed: Sep. 2, 2013
(86) PCT No.: PCT/JP2013/005167

§ 371 Date: Apr. 28, 2015

(30) Foreign Application Priority Data
Oct. 30, 2012 (JP) 2012-239141

(51) Int. Cl. H04N 5/247; B60R 1/00; H04N 5/262

(52) U.S. Cl. CPC H04N 5/247; H04N 5/2624; H04N 5/2628; B60R 1/00; B60R 2300/105; B60R 2300/303

(57) ABSTRACT

An onboard image generator is provided. The onboard image generator includes a first camera capturing an image in front of or behind a vehicle, and a second camera and a third camera capturing images on right and left sides of the vehicle, respectively. Based on the images captured by the second and third cameras, a first viewpoint converter generates a set of symmetrical viewpoint conversion images shaped viewed toward the front or rear of the vehicle from a pair of parallel virtual viewpoints. Based on the image captured by the first camera, a center image generator generates a center image. A combined image generator generates a combined image by arranging the center image in a center of and arranging the set of viewpoint conversion images besides the center image.

### CROSS REFERENCE TO RELATED APPLICATIONS

The present application is based on Japanese Patent Application No. 2012-239141 filed Oct. 30, 2012, the entire contents of which are incorporated herein by reference.

### TECHNICAL FIELD

The present disclosure relates to an onboard image generator that generates viewpoint conversion images from images captured by multiple cameras mounted on a vehicle, and combines the generated images together to generate a combined image of vehicle front or back.

### BACKGROUND ART

Up to now, a device for generating the combined image of this type has been proposed (for example, refer to PTL 1). From the images captured by the multiple cameras mounted on the vehicle, the device generates a wide-angle viewpoint conversion image for extensively looking over the rear of the vehicle from one viewpoint.

There is also a proposed device (for example, refer to PTL 2). From images captured by multiple cameras mounted on a vehicle, the device generates multiple viewpoint conversion images with different viewpoints, and combines the multiple viewpoint conversion images together for generating a panoramic image.

### PRIOR ART LITERATURES

### Patent Literatures

PTL 1: JP-3286306B

PTL 2: JP-2005-242606A

### SUMMARY OF INVENTION

However, the device disclosed in the above Patent Literature 1 generates the wide-angle viewpoint conversion images viewed from a specific viewpoint with the use of the images captured by the multiple cameras. Therefore, a combined image finally obtained is largely distorted on its periphery (in particular, on both of the right and left sides), and becomes extremely difficult to view.

In the device disclosed in the above Patent Literature 2, since the right and left images to be combined together are the viewpoint conversion images viewed from different viewpoints, the right and left, the respective images before being combined together are little distorted, and a combined image finally obtained also becomes easy to view.

However, since the device disclosed in the above Patent Literature 2 combines together the multiple viewpoint conversion images having different viewpoints without making any changes, the image blurs at a boundary portion where the respective viewpoint conversion images are superimposed on each other. As a result, an object present at the boundary portion cannot be recognized from the combined image.

The present disclosure has been made in view of the above circumstances. The present disclosure concerns a device for generating a combined image with use of multiple viewpoint conversion images and has an object to restrain an image from being distorted and prevent the image from blurring at a boundary portion of respective images.

An onboard image generator according to an example of the present disclosure comprises a first camera that captures an image in front of or behind a vehicle in a travel direction of the vehicle; and a second camera and a third camera that capture images on right and left sides of the vehicle, respectively. Based on the images captured by the second camera and the third camera, a first viewpoint conversion unit generates a set of viewpoint conversion images shaped symmetrical to each other and viewed toward the front or rear of the vehicle in the travel direction of the vehicle from a pair of virtual viewpoints having parallel visual axes that are different than visual axes of the second camera and the third camera. Based on the image captured by the first camera, a center image generation unit generates a center image used for generation of a combined image. When the set of viewpoint conversion images and the center image are generated, a combined image generation unit generates the combined image by arranging the center image generated by the center image generation unit in a center of the combined image and arranging the set of viewpoint conversion images generated by the first viewpoint conversion unit besides the center image.

According to the above-mentioned onboard image generator, the combined image can be prevented from blurring at the boundary portion where the respective viewpoint conversion images are superimposed on each other, unlike the conventional device that combines the different-viewpoint conversion images with each other without any change.

The images constituting the combined image include the right and left viewpoint conversion images different in viewpoint, and the center image generated from the image captured by the first camera. In those respective images, the image is not largely distorted on both of the right and left sides, unlike the images captured by a wide-angle camera.

Therefore, according to the above-mentioned onboard image generator, an image easily viewable to a user without any image distortion and any blurring portion can be generated.

### BRIEF DESCRIPTION OF DRAWINGS

The above and other objects, features, and advantages of the present disclosure will become more apparent from the below detailed description made with reference to the accompanying figures. In the drawings,

FIG. 1 is a block diagram illustrating a configuration of an image processing system according to an embodiment.

FIG. 2 is a flowchart illustrating a combined image display process executed by a control unit in FIG. 1.

FIG. 3A is an illustrative view illustrating placement of onboard cameras and viewpoint conversion operation of captured images in a state where a vehicle is viewed from above.

FIG. 3B is an illustrative view illustrating the placement of the onboard cameras and the viewpoint conversion operation of the captured images in a state where a rear portion of the vehicle is viewed from a right side.

FIG. 4 is an illustrative view illustrating an example of a combined image generated by a combined image display process.

FIG. 5 is an illustrative view illustrating a modification of the combined image illustrated in FIG. 4.

FIG. 6 is a flowchart illustrating a combined image display process for generating the combined image illustrated in FIG. 5.

### EMBODIMENTS FOR CARRYING OUT INVENTION

Embodiments of the present disclosure will be described below with reference to the drawings.

Embodiments of the present disclosure are not limited to the following embodiments. In addition, modes lacking a part of the configurations of the following embodiments are also embodiments of the present disclosure as long as they can solve the problem to be solved. Moreover, all considerable modes without departing from the scope of technical matters identified by only wording described in the following embodiments are embodiments of the present disclosure.

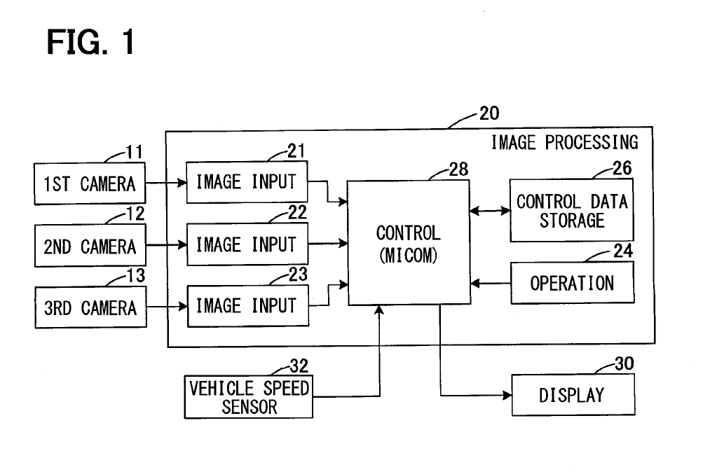

An image processing system according to this embodiment is mounted on a vehicle, and configured to capture and display images around the vehicle. As illustrated in FIG. 1, the image processing system includes three onboard cameras 11 to 13, an image processing device 20, a display device 30, and a vehicle speed sensor 32.

The onboard cameras 11 to 13 are cameras having an imaging element such as a CCD or a CMOS.

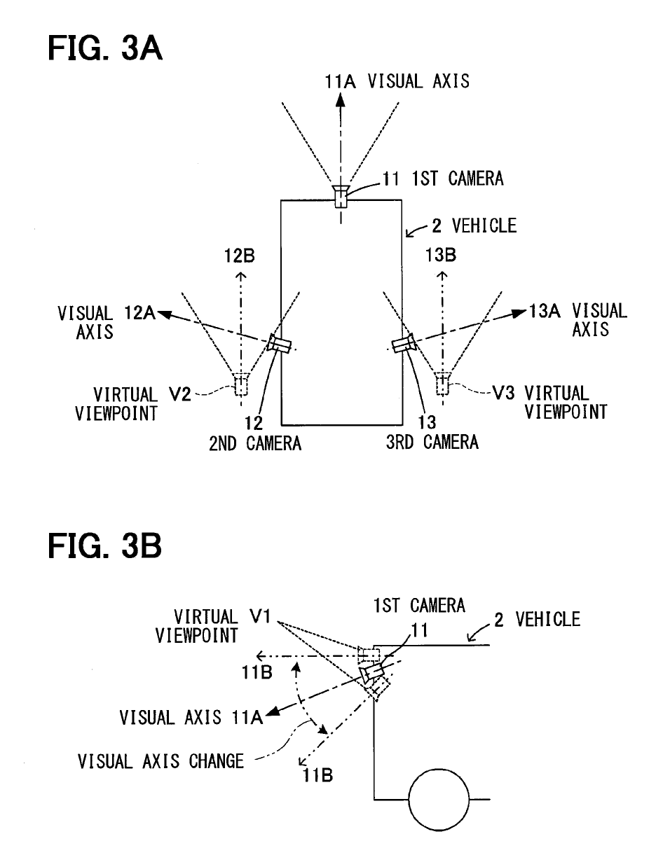

As illustrated in FIGS. 3A and 3B, one of those three onboard cameras 11 to 13 (hereinafter referred to as “first camera 11”) is arranged at a center position of a vehicle 2 in a width direction with a visual line 11A directed toward the rear side of the vehicle 2 so as to capture an image behind the vehicle 2.

As illustrated in FIG. 3A, the remaining two of the three onboard cameras 11 to 13 (hereinafter referred to as “second camera 12 and third camera 13”) are arranged on both of the right and left sides of the vehicle 2 with visual axes 12A and 12B directed toward outside of the vehicle 2 so as to capture images on the right and left sides of the vehicle 2.

Those respective onboard cameras (first camera 11, second camera 12, and third camera 13) output the respective captured images around the vehicle to the image processing device 20 at a predetermined frequency (for example, 60 frames per second).

FIG. 3A illustrates the vehicle 2 viewed from above, and FIG. 3B illustrates a rear end of the vehicle 2 viewed from the right side. The respective onboard cameras (first camera 11, second camera 12, and third camera 13) are placed as indicted by solid lines in the figure.

The display device 30 includes a liquid crystal display or an organic EL display or the like, and displays an image output from the image processing device 20 on the basis of the images captured by the onboard cameras (first camera 11, second camera 12, and third camera 13).

The vehicle speed sensor 32 is configured to detect a travel speed (vehicle speed) of the vehicle 2, and the vehicle speed detected by the vehicle speed sensor 32 is input to the image processing device 20 directly or through an vehicle control ECU (electronic control unit not shown).

The image processing device 20 includes image input units 21 to 23 corresponding to the above respective onboard cameras (first camera 11, second camera 12, and third camera 13), an operating unit 24, a control data storage unit 26, and a control unit 28.

The image input units 21 to 23 include storage devices such as a DRAM, and take the captured images sequentially output from the respective onboard cameras (first camera 11, second camera 12, and third camera 13). The image input units 21 to 23 store the taken images for a predetermined time (for example, for past ten minutes).

The operating unit 24 allows a user such as a driver to input various operating instructions to the control unit 28. The operating unit 24 includes a touch panel disposed on a display surface of the display device 30 or mechanical key switches or the like installed around the display device 30 or other places.

The control data storage unit 26 includes a nonvolatile storage device such as a flash memory, and stores programs to be executed by the control unit 28, and data necessary for various image processing.

The control unit 28 includes a microcomputer with a CPU, a RAM, a ROM, an I/O and the like, and reads the programs from the control data storage unit 26 to execute various processing.

Hereinafter, the operation of the image processing device 20 will be described.

In the following description, combined image display processing that may be main processing of the present disclosure in the various image processing to be executed by the image processing device 20 (in detail, control unit 28) will be described.

The combined image display processing is repetitively executed in the control unit 28 when an operation mode of the image processing device 20 is set to a display mode of the combined image through the operating unit 24.

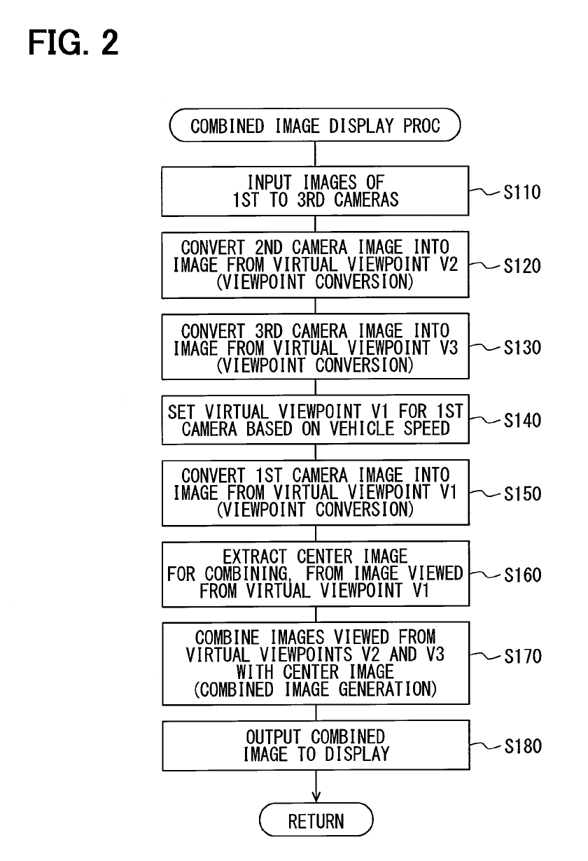

As illustrated in FIG. 2, when the combined image display processing starts, the images captured by the above respective onboard cameras (first camera 11, second camera 12, and third camera 13) are first taken through the image input units 21 to 23 in S110 (S represents a step).

Subsequently, a left side viewpoint conversion image viewed toward the rear of the vehicle from a virtual viewpoint V2 (refer to FIG. 3A) outside the vehicle 2 in the left direction is generated with the use of the image captured by the second camera 12 in S120. The virtual viewpoint V2 is set on a visual axis 12B parallel to the center axis of the vehicle 2 in an anteroposterior direction of the vehicle 2.

A right side viewpoint conversion image viewed toward the rear of the vehicle from a virtual viewpoint V3 (refer to FIG. 3A) outside the vehicle 2 in the right direction is generated with the use of the image captured by the third camera 13 in S130. The virtual viewpoint V3 is set on a visual axis 13B parallel to the center axis (eventually, visual axis 12B) of the vehicle 2 in the anteroposterior direction of the vehicle 2.

In other words, a set of symmetrical viewpoint conversion images viewed from a pair of the virtual viewpoints V2 and V3 are generated on the basis of the images captured by the second camera 12 and the third camera 13, in S120 and S130. The pair of virtual viewpoints V2 and V3 have the respective visual axes 12B and 13B that are parallel to each other and that are different than the visual axes 12A and 13A of the respective cameras 12 and 13.

The virtual viewpoints V2 and V3 are pre-set for rearward image combining of the vehicle 2.

Since the viewpoint conversion to be executed in S120 and S130 has been known up to now as disclosed in PTL 1 and PTL 2, a detailed description of the viewpoint conversion will be omitted.

After the set of right and left viewpoint conversion images have been generated, the processing then proceeds to S140 in which the vehicle speed detected by the vehicle speed sensor 32 is taken and a virtual viewpoint V1 (refer to FIG. 3B) used for generating the viewpoint conversion images from the image captured by the first camera 11 is set based on the taken vehicle speed.

The virtual viewpoint V1 is set so that a visual axis 11B is directed a road surface closer to the vehicle as the vehicle speed is lower, and the visual axis 11B is directed at a place farther from the vehicle as the vehicle speed is higher (in other words, so that an angle (depression angle or depression and elevation angle) of the visual axis 11B in a vertical direction changes according to the vehicle speed) in S140 (refer to FIG. 3B).

Then, in S150, the image captured by the first camera 11 is converted into the viewpoint conversion image behind the vehicle, which is viewed from the virtual viewpoint V1 set in S140. In subsequent S160, a center image for image combining is extracted from the converted viewpoint conversion image.

The virtual viewpoint V1 is given so that when the image captured by the first camera 11 is converted into the image at the time of directing the first camera 11 at a place close to the vehicle or a place far from the vehicle, the viewpoint-converted image matches the set of viewpoint conversion images generated in S120 and S130 at an arbitrary position of the viewpoint-converted image in the vertical direction.

That is, in not only a lateral direction of the vehicle 2 but also the anteroposterior direction of the vehicle 2, the viewpoint of the image captured by the first camera 11 is different from the virtual viewpoints V2 and V3 of the viewpoint conversion images generated in S120 and S130.

For that reason, the image captured by the first camera 11 may be displaced from the set of viewpoint conversion images generated in S120 and S130 in not only the lateral direction of the vehicle 2, but also the anteroposterior direction of the vehicle 2.

Hence, in the case where the image captured by the first camera 11 is merely cut and converted for the purpose of combining the converted image with the set of viewpoint conversion images generated in S120 and S130, the cut captured image may be displaced from the set of viewpoint conversion images in the anteroposterior direction (in other words, a vertical direction of the image) of the vehicle 2.

The cut captured image may be also different from the set of viewpoint conversion images in scale of the image in the vertical direction.

In view of these, in this embodiment, the image captured by the first camera 11 is subjected to viewpoint conversion at the virtual viewpoint V1. As a result, the viewpoint conversion image matches the set of viewpoint conversion images generated in S120 and S130 at least one place of the vehicle 2 in the anteroposterior direction (in other words, vertical direction of the image) in accordance with the position of the virtual viewpoint V1. The combined image becomes easy to view.

The extraction of the center image in S160 is performed by cutting the road surface portion and the street portion behind the vehicle from the viewpoint conversion image generated in the processing of S150 into predetermined shapes.

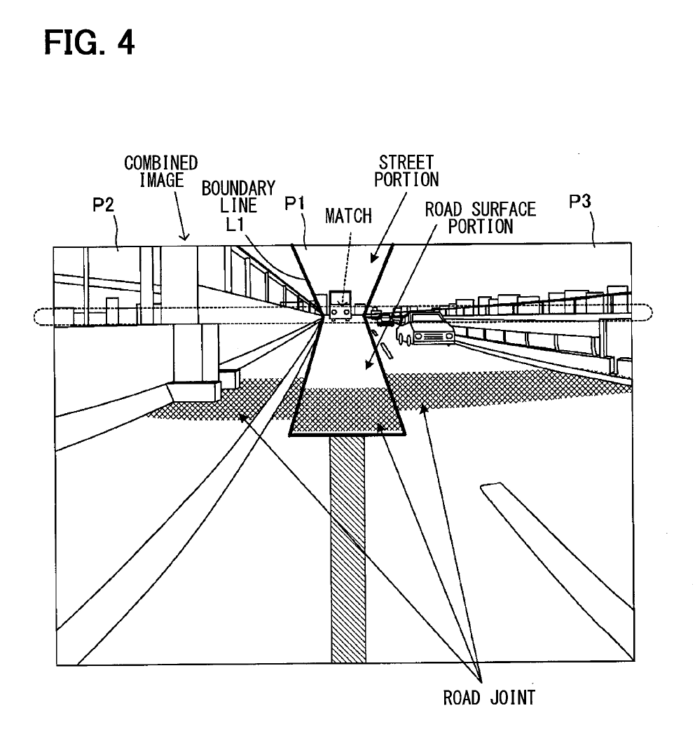

In particular, in this embodiment, as illustrated in FIG. 4, the road surface portion of a center image P1 is cut into a trapezoidal shape whose which a width becomes narrower toward the upper side of the image along the right and left axes parallel to the right and left side walls of the vehicle body of the vehicle 2.

The street portion above the road surface portion is cut into a trapezoidal shape whose width becomes wider toward the upper side of the image from an upper edge of the road surface portion.

For that reason, an outer shape of the center image P1 is elongated and recessed in a center thereof in a vertical direction, and the user can excellently understand a state directly behind the vehicle 2 by only the center image P1.

The extraction of the center image P1 from the viewpoint conversion images is performed with the use of a cut pattern (shape pattern) set in advance according to the virtual viewpoint V1 of the viewpoint conversion image that is an original of the center image P1.

Then, when the center image P1 for image combining is extracted from the viewpoint conversion image of the virtual viewpoint V1 in S160, the processing proceeds to S170 in which a combined image behind the vehicle is generated with the use of the center image P1 and viewpoint conversion images on the right and left sides which are generated in S120 and S130.

The images on the right and left rear sides to be arranged on the right and left of the center image P1 are extracted from the viewpoint conversion images on the right and left sides generated in S120 and S130, and extracted images P2 and P3 are arranged on the right and left of the center image P1 to generate the combined image in S170 (refer to FIG. 4).

When the images P2 and P3 are arranged on the right and left of the center image P1, a boundary line L1 indicative of a boundary between the periphery of the center image P1 and the other images P2, P3 is drawn so that the center image P1, and the right and left images P2 and P3 are distinguishable from each other on the combined image in S170.

This is because the viewpoints (that is, virtual viewpoints V1 to V3) of the respective images P1 to P3 configuring the combined image are different from each other.

That is, for example, as is apparent from a joint portion of a road in the combined image illustrated in FIG. 4, when the above respective images P1 to P3 are combined together, the image is displaced in the vertical direction on the boundary portion of the center image P1, and the right and left images P2, P3.

In view of this, in this embodiment, the boundary line L1 is added to the combined image to clarify that the displacement of the image occurring in the combined image is caused by combining the images P1 to P3 together. This prevents the user who views the combined image from being confused.

In subsequent S180, the combined image generated in S170 is output to the display device 30 to display the combined image on the display device 30, and the combined image display processing is ended.

As described above, according to the image processing device 20 of this embodiment, not only the viewpoint conversion images viewed from the virtual viewpoints V2 and V3 on the right and left sides of the vehicle 2 are generated from the images captured by the second camera 12 and the third camera 13, but also the center image P1 behind the vehicle is generated from the image captured by the first camera 11.

Then, the images P2 and P3 on the right and left rear, which are cut from the right and left viewpoint conversion images, are arranged on the right and left of the generated center image P1 to generate the combined image, which is displayed on the display device 30.

For that reason, the combined image can be prevented from blurring on the boundary portion where the respective viewpoint conversion images are superimposed on each other, unlike the conventional device that combines the right and left viewpoint conversion images together without any change.

The images constituting the combined image include the right and left images P2 and P3 extracted from the right and left viewpoint conversion images, and the center image P1 generated from the image captured by the first camera 11. Those respective images P1 to P3 are not largely distorted on both of the right and left sides unlike the image captured by a wide-angle camera.

Therefore, according to the image processing device 20 of this embodiment, the image easily viewed by the user can be generated without distortion of the image or blurred portions.

In particular, in this embodiment, the virtual viewpoint V1 for the viewpoint conversion image is set according to the vehicle speed and the viewpoint conversion image corresponding to the virtual viewpoint V1 is generated on the basis of the image captured by the first camera 11. The road surface portion and the street portion directly behind the vehicle 2 are cut out of the generated viewpoint conversion image to generate the center image P1.

The virtual viewpoint V1 is set so that the visual axis 11B is directed at the road surface closer to the vehicle than the original visual axis 11A when the vehicle speed is lower, and the visual axis 11B is directed at a place farther from the vehicle 2 than the original visual axis 11A when the vehicle speed is higher.

For that reason, according to this embodiment, a point at which the respective images P1 to P3 match each other in the vertical direction of the image on the combined image can be set to a road surface position close to the vehicle when the vehicle speed is low, and can be set to a road surface position far from the vehicle 2 when the vehicle speed is high.

FIG. 4 illustrates the combined image generated when the vehicle speed is high. As is apparent from the joint portion of the road on the combined image, the center image P1 and the right and left images P2, P3 are displaced from each other in the vertical direction on the joint portion of the road close to the vehicle 2. On the contrary, the center image P1 and the right and left images P2, P3 substantially match each other in the vertical direction in the vicinity of a following vehicle far from the vehicle 2.

Therefore, according to this embodiment, when the vehicle speed is high, it becomes possible to generate the combined image in which the following vehicle is easy to view. On the contrary, when the vehicle speed is low, the joint portion of the road matches each other in the combined image, and the image close to the vehicle 2 can be easily viewed.

For that reason, the user can grasp a road status directly behind the vehicle 2 by viewing the center image P1 within the combined image displayed on the display device 30. For example, the user easily grasps the road surface status close to the vehicle at the time of traveling at low speed or backing, and the travel safety of the vehicle 2 can be improved.

Also, when the vehicle 2 travels at high speed, the user easily grasps the vehicle approaching the vehicle 2 from a long distance, and can perform driving for ensuring the safety such as a lane change from a passing lane to a normal driving lane.

On the display screen of the combined image, since the boundary line L1 is formed between the center image P1 and the images P2, P3 on the right and left rear sides, the user can easily distinguish the respective images P1 to P3 from each other on the display screen.

For that reason, even if the respective images P1 to P3 are displaced from each other in the vertical direction, the user can clearly grasp the road surface status directly behind the vehicle 2 and the road surface status on the right and left rear sides of the vehicle 2 while recognizing the displacement.

Embodiments of the present disclosure are illustrated above, but embodiments of the present disclosure include various modes aside from the above illustrations.

For example, in the above embodiment, in generating the combined image, the image captured by the first camera 11 is converted into the viewpoint conversion image viewed from the virtual viewpoint V1 that is set according to the vehicle speed. As a result, the respective images P1 to P3 constituting the combined image match each other at one place of the combined image in the vertical direction after the images have been combined together.

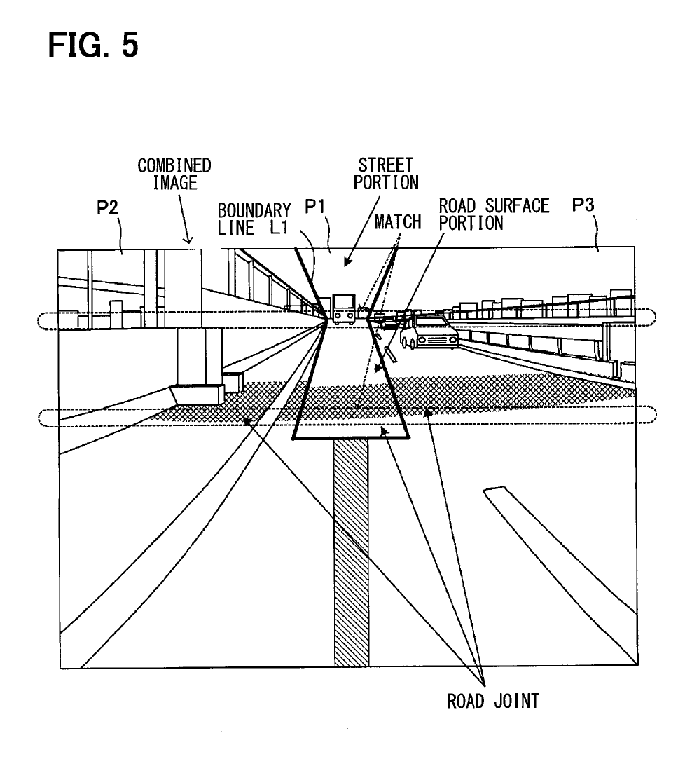

However, for example, as illustrating in FIG. 5, the image captured by the first camera 11 may be converted so that the respective images P1 to P3 match each other at two places (that is, distant position and close position) of the combined image in the vertical direction, and the image continuously changes between the two places in the center image.

With the above processing, the respective images P1 to P3 match each other at the distance position which is an upper side of the combined image, and at the close position that is a lower side of the combined image. As a result, both of the place far from and the vicinity of the vehicle 2 are easily confirmed from the combined image, and the travel safety of the vehicle 2 can be more improved.

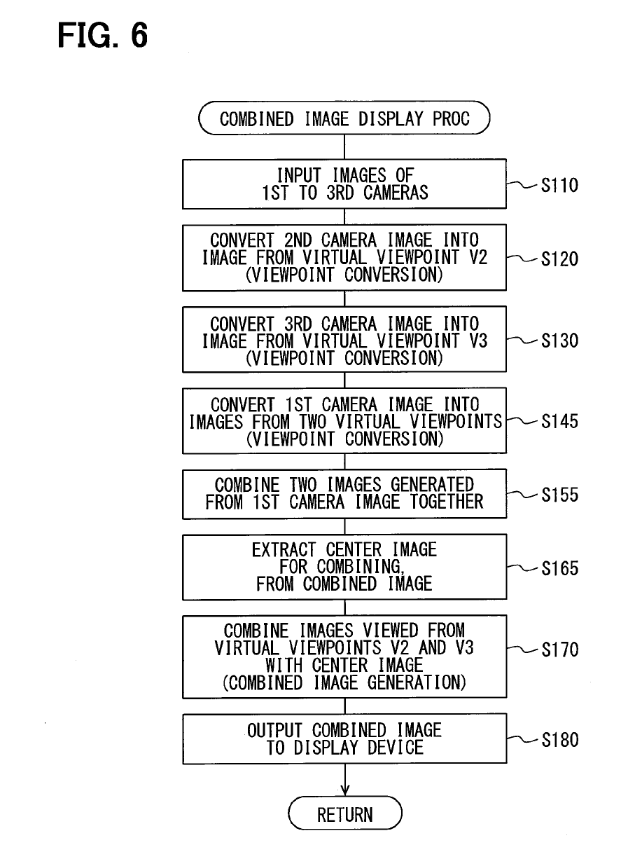

In order to generate the combined image illustrated in FIG. 5, for example, as illustrated in FIG. 6, in the combined image display processing of FIG. 2 which is executed in S110 to S180, the processing in S140, S150, and S160 may be replaced with the processing in S145, S155, and S165.

That is, the image captured by the first camera 11 is viewpoint-converted into the images viewed from two virtual viewpoints different from each other so that the image captured by the first camera 11 matches the right and left images P2 and P3 at two places of the distant position and the close position with respect to the vehicle in generating the combined image, in S145.

The two images obtained by the viewpoint conversion in S145 are combined together so that the images are smoothly continuous to each other between two places where the right and left images P2 and P3 match the image in S155. The center image P1 is extracted from the combined image in which the two viewpoint conversion images are combined together in S155 in the same procedure as that in the above S160, in S165.

In order to generate the combined image illustrated in FIG. 5, the image captured by the first camera 11 may not always need to be converted in the above procedure. Alternatively, a conversion map for converting the captured image as described above is created in advance, and a conversion image for extracting the center image P1 from the image captured by the first camera 11 may be generated with the use of the conversion map.

In the above embodiment, the first camera 11 is arranged behind the vehicle 2, and used to capture the image behind the vehicle. Alternatively, the first camera 11 may be so disposed as to capture the image in front of the vehicle 2.

In this case, since the combined image in front of the vehicle 2 is generated, the viewpoint conversion images viewed toward the front of the vehicle from the virtual viewpoints V2 and V3 along the visual axes 12B and 13B parallel to each other may be generated in S120 and S130.

In the above embodiment, the three onboard cameras (first camera 11, second camera 12, and third camera 13) are used to generate the combined image. Alternatively, at least any the first camera 11, second camera 12, and third camera 13 may be provided as multiple cameras.

In this case, when the viewpoint conversion images are generated from the images captured by the multiple cameras, the respective parts (images P1 to P3) of the combined image can be made clearer.

In the above embodiment, the boundary line L1 is drawn so that the center image P1 is distinguishable from the images P2 and P3 on the right and left rear sides in the generated combined image. However, there may be no need to always draw the boundary line L1 in order to make those respective images P1 to P3 distinguishable from each other.

For example, the respective images P1 to P3 may be formed with a space therebetween as with the boundary portion (hatched portion in FIG. 4) between the right and left images P2 and P3 in the combined image of FIG. 4 so as to display the respective images P1 to P3 distinguishably.

This distinguishably display may not always need to be implemented. Alternatively, the center image P1 and the images P2, P3 on the right and left rear sides may be merely displayed on the same screen.

In the above embodiment, the center image P1 is shaped to cut a trapezoidal road surface portion spread downward, and a trapezoidal street portion spread upward from the original viewpoint conversion image. The cut shape may be also appropriately set.

That is, the shape of the center image P1 can be appropriately changed, for example, formed into a rectangle that is cut with a width corresponding to the rear end portion of the vehicle 2 straight toward the upper side of the image from the original viewpoint conversion image of the center image P1.

In the above embodiment, the original image of the center image P1 is the viewpoint conversion image obtained by converting the image captured by the first camera 11 into the image viewed from the virtual viewpoint V1 that is set according to the vehicle speed. Alternatively, the virtual viewpoint V1 of the viewpoint conversion image may be set in advance.

That is, for example, the virtual viewpoint V1 of the viewpoint conversion image may be fixed to, for example, a position where the road surface status is easily grasped at the time of backing the vehicle 2.

The virtual viewpoint V1 of the viewpoint conversion image may be selected from predetermined multiple candidates by the user.

The original image of the center image P1 may always need to be obtained by subjecting the image captured by the first camera 11 to viewpoint conversion. The image captured by the first camera 11 may be merely used without any change.

In this case, the center image P1 may be extracted (cut) from the captured images by the above-mentioned predetermine cut pattern.

In the above embodiment, the control unit 28 that executes S120 and S130 corresponds to an example of the first viewpoint conversion unit or means. The control unit 28 that executes S160 corresponds to an example of the center image generation unit or means. The control unit 28 that executes S170 corresponds to an example of the center image generation unit or means. The control unit 28 that executes S150 corresponds to an example of the second viewpoint conversion unit or means. The control unit 28 that executes S140 corresponds to an example of the virtual viewpoint setting unit or means. The control unit 28 that executes S145 and S155 corresponds to an example of the image conversion unit or means.

According to the present disclosure, an onboard image generator can be provided with various configurations.

For example, an onboard image generator comprises a first camera that captures an image in front of or behind a vehicle in a travel direction of the vehicle; and a second camera and a third camera that capture images on right and left sides of the vehicle, respectively. Based on the images captured by the second camera and the third camera, a first viewpoint conversion unit generates a set of viewpoint conversion images shaped symmetrical to each other and viewed toward the front or rear of the vehicle in the travel direction of the vehicle from a pair of parallel virtual viewpoints having visual axes that are different than visual axes of the second camera and the third camera. Based on the image captured by the first camera, a center image generation unit generates a center image used for generation of a combined image. When the set of viewpoint conversion images and the center image are generated, a combined image generation unit generates the combined image by arranging the center image generated by the center image generation unit in a center of the combined image and arranging the set of viewpoint conversion images generated by the first viewpoint conversion unit besides the center image.

The onboard image generator may further comprise a second viewpoint conversion unit. Based on the image captured by the first camera, the second viewpoint conversion unit generates a viewpoint conversion image viewed from a virtual viewpoint with a visual axis directed toward a place closer to farther from the vehicle than the image captured by the first camera. The center image generation unit generates the center image based on the viewpoint conversion image generated by the second viewpoint conversion unit.

The onboard image generator may further comprise a virtual viewpoint setting unit that sets the virtual viewpoint when the second viewpoint conversion unit generates the viewpoint conversion images by directing the visual axis toward the place closer to the vehicle as a travel speed of the vehicle is lower and directing the visual axis toward the place farther from the vehicle as the travel speed of the vehicle is higher, according to the travel speed of the vehicle.

The onboard image generator may further comprise an image conversion unit that converts the image captured by the first camera, so that, in the combined image generated by the combined image generation unit, the center image positionally matches the set of viewpoint conversion images generated by the first viewpoint conversion unit at two places in the center image being a farther position and a closer position with respect to the vehicle and the center image continuously changes between the two places. The center image generation unit generates the center image based on the captured images converted by the image conversion unit.

The center image generation unit (28, S160) may generate, as the center image, an image including: a road surface portion that is cut out of an original image of the center image to have a width that is narrowed toward a top of the image along right and left axes parallel to right and left side walls of a vehicle body of the vehicle; and a street portion that is cut out of the original image of the center image to have a width that is spread toward the top of the image from an upper edge of the road surface portion.

The combined image generation unit (28, S170) generates the combined image in which a boundary between the center image and the set of viewpoint conversion images is distinct.

Embodiments and configurations according to the present disclosure have been illustrated but embodiments and configurations according to the present disclosure are not limited to the respective embodiments and the respective configurations described above. Embodiments and configurations obtained by appropriately combining the respective technical elements disclosed in different embodiments and configurations are also included in embodiments and configurations according to the present disclosure.

1. An onboard image generator comprising:
a first camera that captures an image in front of or behind a vehicle in a travel direction of the vehicle;
a second camera and a third camera that capture images on right and left sides of the vehicle, respectively;
a first viewpoint conversion unit that, based on the images captured by the second camera and the third camera, generates a set of viewpoint conversion images shaped symmetrical to each other and viewed toward the front or rear of the vehicle in the travel direction of the vehicle from a pair of virtual viewpoints having parallel visual axes that are different than visual axes of the second camera and the third camera;
a center image generation unit that, based on the image captured by the first camera, generates a center image used for generation of a combined image; and
a combined image generation unit that generates the combined image by arranging the center image generated by the center image generation unit in a center of the combined image and arranging the set of viewpoint conversion images generated by the first viewpoint conversion unit besides the center image.

2. The onboard image generator according to claim 1, further comprising:
a second viewpoint conversion unit that, based on the image captured by the first camera, generates a viewpoint conversion image viewed from a virtual viewpoint with a visual axis directed toward a place closer to farther from the vehicle than the image captured by the first camera, wherein
the center image generation unit generates the center image based on the viewpoint conversion image generated by the second viewpoint conversion unit.

3. The onboard image generator according to claim 2, further comprising:
a virtual viewpoint setting unit that sets the virtual viewpoint when the second viewpoint conversion unit generates the viewpoint conversion images by directing the visual axis toward the place closer to the vehicle as a travel speed of the vehicle is lower and directing the visual axis toward the place farther from the vehicle as the travel speed of the vehicle is higher, according to the travel speed of the vehicle.

4. The onboard image generator according to claim 1, further comprising:
an image conversion unit that converts the image captured by the first camera, so that, in the combined image generated by the combined image generation unit, the center image positionally matches the set of viewpoint conversion images generated by the first viewpoint conversion unit at two places in the center image being a farther position and a closer position with respect to the vehicle and the center image continuously changes between the two places,
wherein the center image generation unit generates the center image based on the captured images converted by the image conversion unit.

5. The onboard image generator according to claim 1, wherein
the center image generation unit generates, as the center image, an image including:
a road surface portion that is cut out of an original image of the center image to have a width that is narrowed toward a top of the image along right and left axes parallel to right and left side walls of a vehicle body of the vehicle; and
a street portion that is cut out of the original image of the center image to have a width that is spread toward the top of the image from an upper edge of the road surface portion.

6. The onboard image generator according to claim 1, wherein
the combined image generation unit generates the combined image in which a boundary between the center image and the set of viewpoint conversion images is distinct.
